(19) United States
(12) Patent Application Publication
(10) Pub. No.: US 2013/0061537 A1
(43) Pub. Date: Mar. 14, 2013

(54) RAIN GUTTER GUARD AND METHOD FOR INSTALLATION

(71) Applicant: FORSIGHT MANUFACTURING, INC., Rochester, WA (US)

(72) Inventor: Ben Hawes, Fircrest, WA (US)

(73) Assignee: FORSIGHT MANUFACTURING, INC., Rochester, WA (US)

(21) Appl. No.: 13/670,260

(22) Filed: Nov. 6, 2012

Related U.S. Application Data
(63) Continuation of application No. 12/939,944, filed on Nov. 4, 2010, now abandoned.

(51) Int. Cl. E04D 13/076; B23P 11/00

(52) U.S. Cl. 52/12; 29/428

(57) ABSTRACT

The invention relates to an apparatus that prevents rain gutters for clogging and, more particularly, a gutter guard.

### CROSS-REFERENCES TO RELATED APPLICATIONS

This application is a continuation of U.S. application Ser. No. 12/939,944, filed on Nov. 4, 2010, currently pending, and incorporates that application in its entirety herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### TECHNICAL FIELD

The invention described herein relates to an apparatus that prevents rain gutters from clogging and, more particularly, a gutter guard that can be fitted to rain gutters.

### BACKGROUND OF INVENTION

Rain gutters are attached on most, if not all, commercial and residential structures so that rain is moved away from structures. Rain gutters are usually cleaned at least once a year to remove debris that may have accumulated preventing water from moving through. Leaves, twigs, acorns, insects, vermin, and birds nest, for example, are considered debris because they clog gutters and impede the natural flow of water away from the structure. Depending on the location of the structure (e.g. those is heavily wooded areas) gutters may need to be cleaned more often.

Cleaning rain gutters is a time consuming and laborious task. Additionally, depending on the size and pitch of the roof, cleaning a rain gutter can be dangerous. If debris is not cleaned, the gutters will become a breeding ground for pests and animals. Debris can cause damage to fascia boards and the interior of the structure.

Attempts to solve the problem of clogged rain gutters take one of two forms: (1) the gutter is covered with a mesh or net, as shown in FIG. 1; or (2) the gutter is covered with a protective cap that channels water into the gutter, as shown in FIG. 2. Like the rain gutters, the mesh and protective caps eventually become clogged with debris that needs to be cleaned.

### BRIEF DESCRIPTION OF INVENTION

It is, therefore, an object of this invention to provide an improved rain gutter guard which allows water to move through a rain gutter while pushing away debris from the structure so that there is little or no need to clean the gutter. Another object of this invention is to provide a rain gutter guard which can be retrofitted to any type of roofing.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an exemplary drawing of prior art;

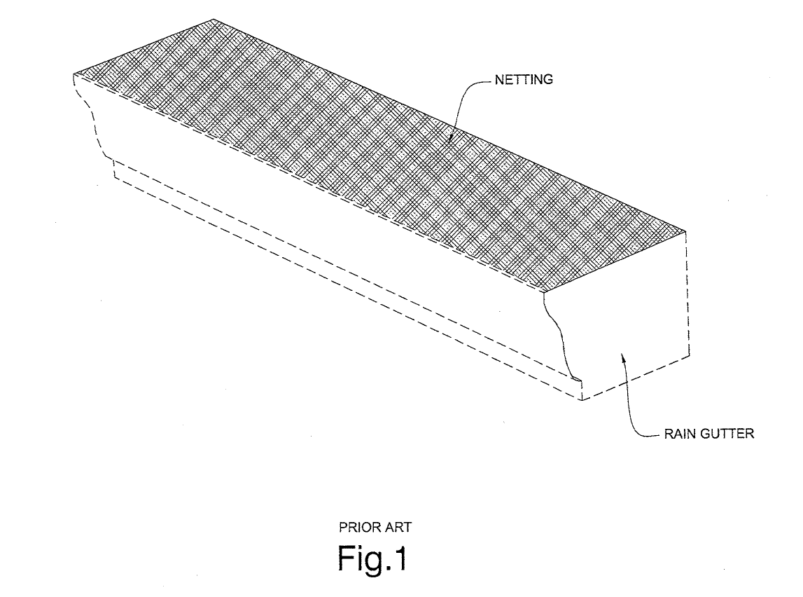

FIG. 2 is an exemplary drawing of prior art;

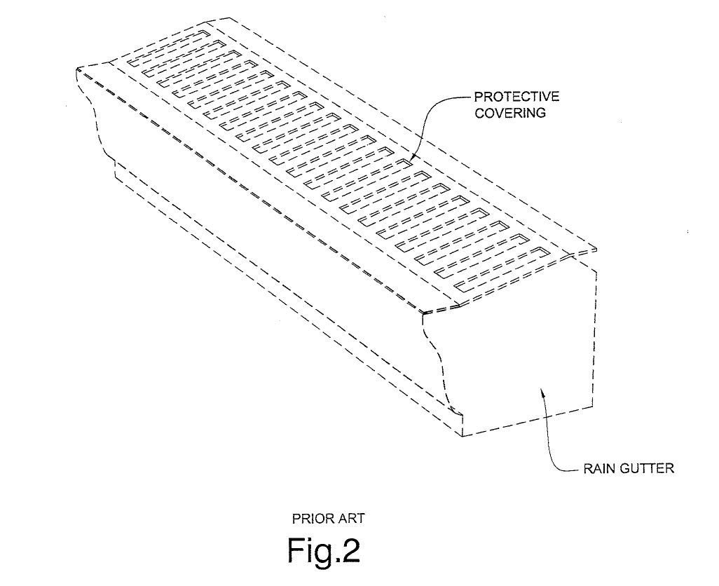

FIG. 3 is a perspective view of the invention;

FIG. 4 is an environmental, side view of the invention;

FIG. 5 is an exploded view of the invention;

FIG. 5a is a detail view of a Pittsburgh Seam

FIG. 6a is a top view of the invention described herein;

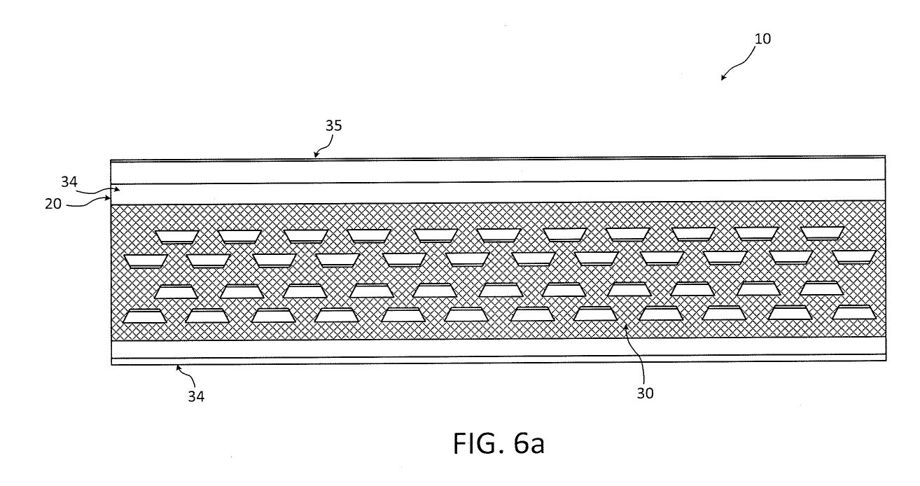

FIG. 6b is a bottom view of the invention described herein;

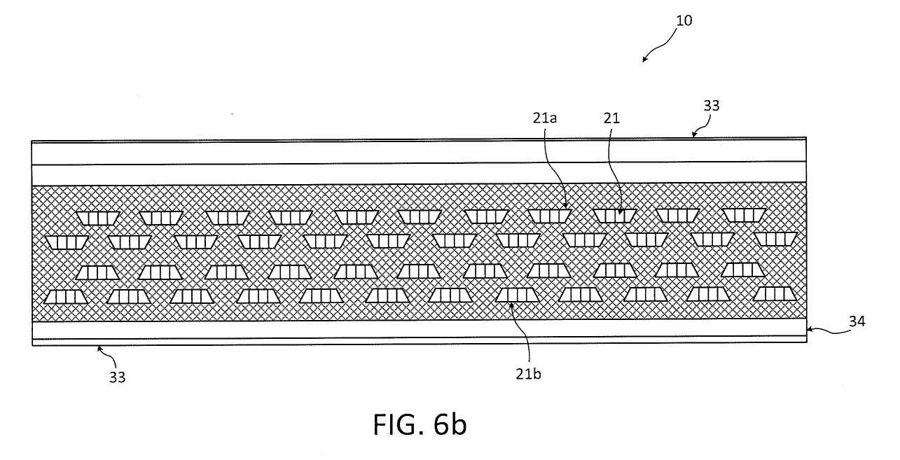

FIG. 7 is an environmental, side view of the invention described herein in a preferred embodiment.

### DETAILED DESCRIPTION OF THE INVENTION

In the description of the invention above and in the detailed description of the invention, and the claims below, and in the accompanying drawings, reference is made to particular features (including method steps) of the invention. It is to be understood that the disclosure of the invention in this specification includes all possible combination of such particular features. For example, where a particular feature is disclosed in the context of a particular aspect or embodiment of the invention, or a particular claim, that feature can also be used, to the extent possible , combination with and/or in the context of other particular aspects and embodiments of the invention, and in the invention generally.

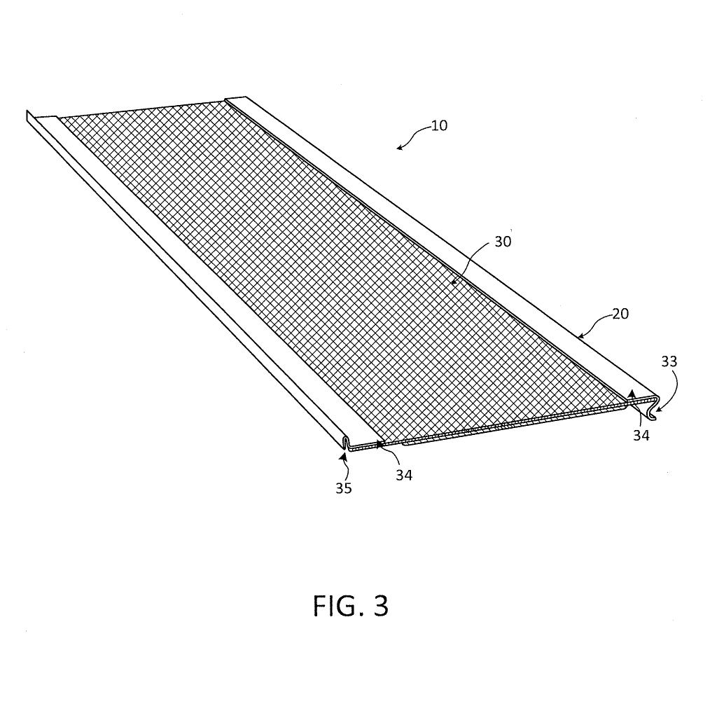

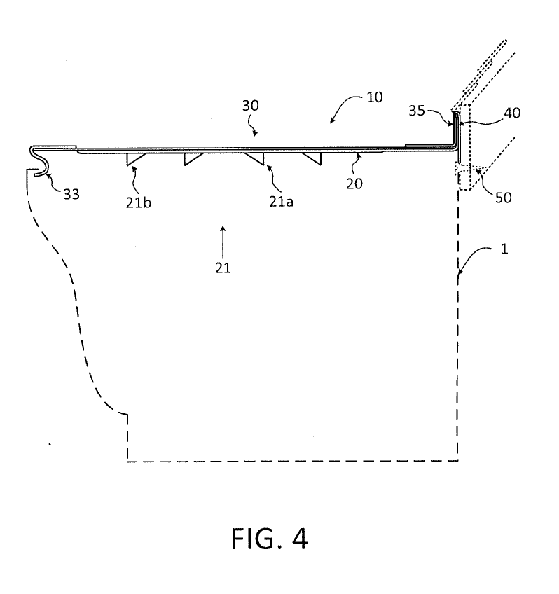

The invention described herein is a rain gutter guard (10) (hereafter referred to as “gutter guard” or “guard”) where FIG. 3 is a perspective view of the gutter guard (10). The gutter guard (10) can be installed when roofing is installed or retro-fitted into a conventional rain gutter system. FIG. 4 is an exemplary side view of the gutter guard (10) installed on a conventional rain gutter (1) where a conventional rain gutter (1) is defined as a conduit which is secured to a support plate or fascia of the roof structure by conventional means.

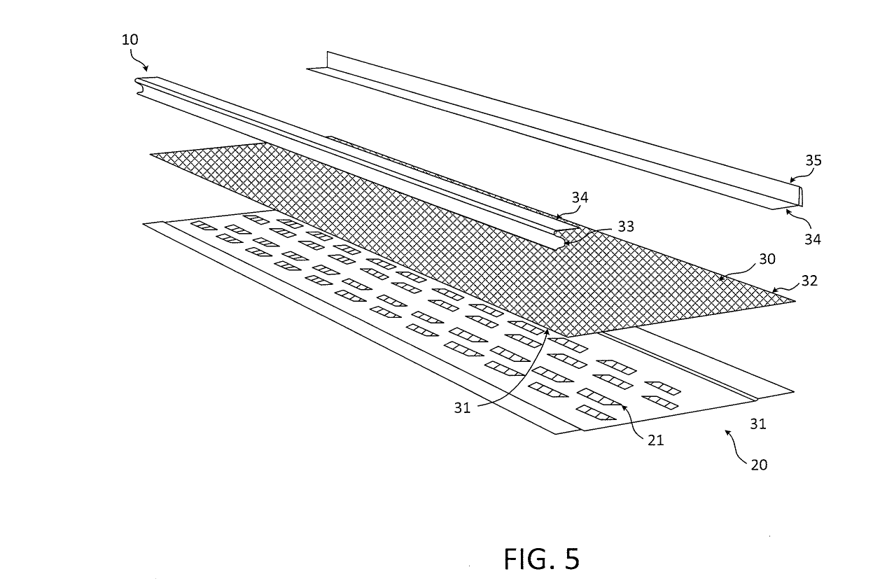

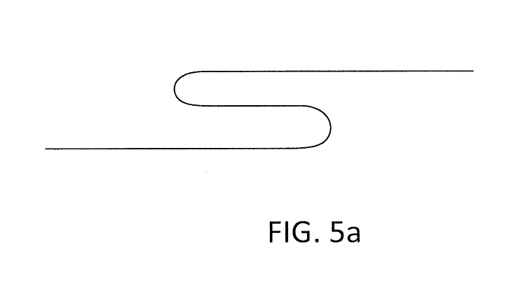

FIG. 5 is an exploded view of the of the gutter guard (10). The gutter guard is comprised of a guard shell (20) and mesh screen (30). In a preferred embodiment, the guard shell (20) is molded as an integral unit from plastic, vinyl, aluminum, or other water resistant material. A plurality of louvers (21) is formed into the guard shell (20). In the preferred embodiment, a portion of the louvers (21) are formed in a first direction (21a) and half the louvers are formed in a second direction (21b). In a preferred embodiment, the mesh screen (30) is made of stainless steel. However, it will be obvious to a person having ordinary skill in the art that the mesh screen can be made from any sturdy, water proof material. Ideally, the mesh is 24 or 30 mesh.

The mesh screen (30) has a near end (31) and a far end (32). The guard shell (20) is attached to the mesh screen (30) at the near end (31) and the far end (32). At near end (31) the mesh is attached to the guard shell (20) with a Pittsburgh Seam (34) having a bent flange (33). At the far end (32) the mesh (30) is attached to the guard shell (20) with a Pittsburgh Seam (34) which extends into a standing seam (35). Preferably, a space is defined between the mesh (30) and the guard shell (20) when the mesh (30) is attached to the guard shell (20). A detailed view of a Pittsburgh Seam known in the art is shown in FIG. 5a.

The purpose of the louvers (21) is to pull and direct water away from the structure, toward the rain gutter (1). The purpose of the mesh screen (30) is to keep debris from entering the gutter. The standing seam (35) prevents water from entering or being splashed onto the structure.

Referring to FIG. 4, the gutter guard (10) can be installed when the roof is being installed onto the structure. The standing seam (35) sits on top of a rain gutter hanger and bracket or a spike and ferrule connection (40) and extends toward the structure. The standing seam (35) is secured to the structure; in most cases, a screw is used. Rain gutter hanger and bracket and spike and ferrule connections are well known in the art and therefore, are not discussed in detail here. In this configuration, the louvers (21) face the rain gutter (1).

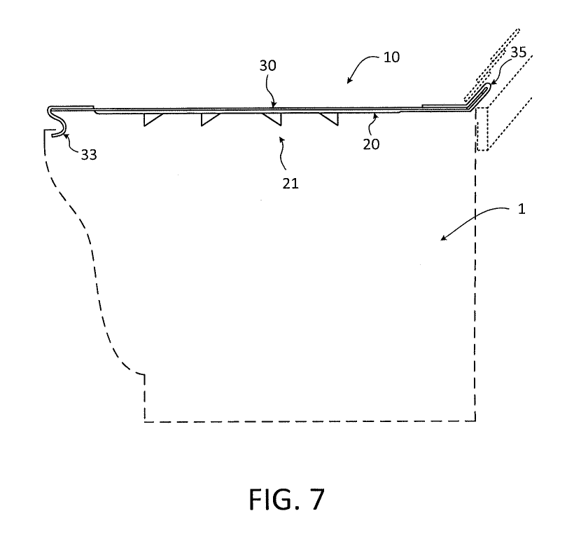

The gutter guard (10) can be installed onto the structure after the roofing has been installed. Referring to FIG. 7, in a one preferred installation method, the standing seam (35) is flattened and tucked under roofing shingle and extended toward the structure. The standing seam (35) is secured to the structure; in most cases, a screw is used. This method is used prior to gutter (1) installation. In this configuration, the louvers (21) face the rain gutter (1).

1. A rain gutter guard comprised of a guard shell and mesh screen:
(a) where mesh screen has a near end and a far end;
(b) where guard shell is attached to the mesh screen at the near end and the far end;
(c) where the near end is attached to the guard shell with a Pittsburgh Seam having a bent flange;
(d) where the far end is attached to the guard shell with a Pittsburgh Seam which extends into a standing seam;
(e) where the guard shell comprises a plurality of louvers; a portion of the louvers face a first direction and a portion face a second direction.

2. A method to install the rain gutter guard of claim 1 onto a structure comprises placing the standing seam on top of a rain gutter hanger and bracket or a spike and ferrule connection.

3. A method to install the rain gutter guard of claim 1 onto a structure comprises tucking the standing seam under roofing shingle.
